(19) United States
(12) Patent Application Publication
(10) Pub. No.: US 2009/0166267 A1
(43) Pub. Date: Jul. 2, 2009

(54) METHOD WHICH TURNS CONSTRUCTION WASTES INTO BUILDING MATERIALS

(75) Inventor: Li Wang, Beijing (CN)

Correspondence Address: YING CHEN;Chen Yoshimura LLP, 255 S. GRAND AVE., # 215, LOS ANGELES, CA, 90012, US

(73) Assignee: BEIJING HENGYECUN S&T CO., LTD, Beijing (CN)

(21) Appl. No.: 11/967,169

(22) Filed: Dec. 29, 2007

(30) Foreign Application Priority Data
Dec. 27, 2007 (CN) 200710304327.8

(51) Int. Cl. B03C 1/30; E04G 21/02

(52) U.S. Cl. 209/40; 52/745.19

(57) ABSTRACT

This invention relates to a method which turns construction wastes into building materials said method separating construction wastes into heavy materials, light materials and mineral materials by sorting, magnetic separating, primarily crushing and separating by gravity, said mineral materials to be used as raw materials of building material, said building materials comprising fibrous material of 5-10 portions, said mineral material of 40-60 portions, low-water cement of 20-30 portions and other materials of 0-30 portions. This method makes good use of mineral materials, the main part of construction waste to save material resource and to reduce final discharge amount of construction waste.

### BACKGROUND OF THE INVENTION

1. Field of the Invention

This invention related to environment protection and building material and more particularly to a method which turns construction wastes into building materials.

2. Description of the Related Art

Construction waste mainly refers to the waste produced during construction, decoration as well removing buildings and mainly consists of inorganic substances. According to existing regulations, those wastes shall be concentrated in special disposal plant for later processing. There are two common processing modes, one is stacking them in dumping place and the other is that they will serve as cushions for temporary construction roadways, which will eventually be removed to the dumping place. Because construction waste is non-degradable, they will occupy a large area and also will invite problems like sand blowing. On the other hand, as the development of architecture, the manufacture of building materials will consume large quantity of non-metallic minerals and mineral mining has already affected the local environment in some areas. Therefore how to make use of the construction waste, to realize mineral resource recycling is an important issue in front of us.

### SUMMARY OF THE INVENTION

This invention concerns a method which turns construction wastes into building materials. There the urban building materials will be sorted, dressed by magnetic separation, primarily crushed and dressed by gravity separation. The construction wastes will be separated into heavy material, light material and mineral material which will be used to manufacture building material after secondarily crushed. The raw materials of the building material include: fibrous material 5-10 portions, mineral material 40-60 portions, low-water cement 20-30 portions and other materials 0-30 portions. The manufacturing process of the building material is firstly mixing the fibrous material, the mineral material and other materials uniformly, then mixing the low-water cement in and blending the mixture into slurry by adding water, finally pouring the slurry into moulds and vibrating or pressing to form it into shape, and building slabs will come into being after natural curing. This invention makes good use of mineral material, the main part of construction waste, saves material resource, reduces the final discharge amount of construction waste and produces hollow bricks, hollow building blocks, partition slabs and other building materials.

To make up the deficiency of present techniques on building material recycling, this invention offers a method which turns construction wastes into building materials, dedicating to construction waste recycling to produce building materials.

The technical plan of the above invention is: in this method which turns construction wastes into building materials, the urban building materials will be sorted, dressed by magnetic separation, primarily crushed and dressed by gravity separation. The construction wastes will be separated into heavy material, light material and mineral material which will be used to manufacture building material after secondarily crushed. The raw materials of the building material include: fibrous material 5-10 portions (quality portions, the same below), mineral material 40-60 portions, low-water cement 20-30 portions and other materials 0-30 portions.

The manufacturing process of the building material is firstly mixing the fibrous material, the mineral material and other materials uniformly, then mixing the low-water cement in and blending the mixture into slurry by adding water, finally pouring the slurry into moulds and vibrating or pressing to form it into shape, and building slabs will come into being after natural curing.

For the raw materials in this invention coming from construction waste and with a larger specific gravity, this will greatly reduce resource consumption and final discharging amount of the construction waste by changing waste into valuable; the low-water cement used here, as binding material, is of great binding power. The hollow blocks produced here possesses a compressive strength>7.5 MPa and a high quality while consuming less cement. It can produces hollow bricks, hollow building blocks, partition slabs and other building materials if needed.

### BRIEF DESCRIPTION OF THE DRAWINGS

FIG. 1 shows the structural scheme of this invention.

### DETAILED DESCRIPTION OF THE PREFERRED EMBODIMENTS

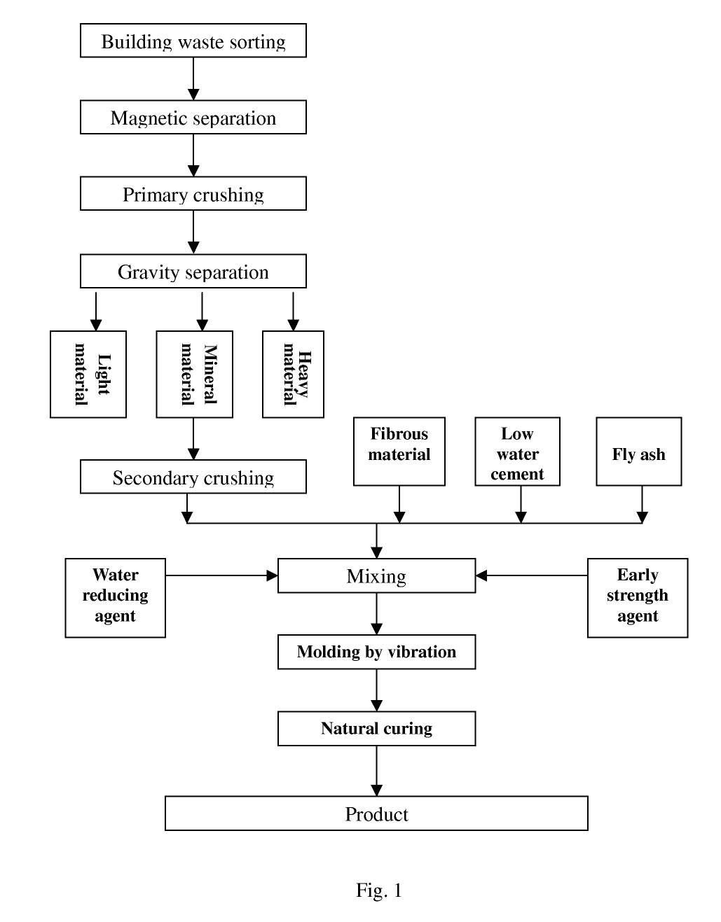

See FIG. 1, this invention offers a method which turns construction wastes into building materials. The urban building materials will be sorted, dressed by magnetic separation, primarily crushed and dressed by gravity separation. The construction wastes will be separated into heavy material, light material and mineral material which will be used to manufacture building material after secondarily crushed. The raw materials of the building material include: fibrous material 5-10 portions, mineral material 40-60 portions, low-water cement 20-30 portions and other materials 0-30 portions.

The manufacturing process of the building material is firstly mixing the fibrous material, the mineral material and other materials uniformly, then mixing the low-water cement in and blending the mixture into slurry by adding water, finally pouring the slurry into moulds and vibrating or pressing to form it into shape, and building slabs will come into being after natural curing.

The sorting will be performed by manual work or machines to select staple or massive steel bars, boards or other materials from the mineral material in building wastes. For there are not too many kinds among the waste and the bulks or length of other materials except mineral material are large, the remained materials are almost minerals after sorting. The other separated stuffs include metal material, wooden material and organic materials such as plastic, which can be recycled according to their own characters.

Magnetic separation will follow the sorting. Generally suspended suction magnetic separator will be employed in the magnetic separation to separate remained iron pieces from the waste meanwhile to avoid iron pieces damaging the subsequent equipments.

Jaw crusher will be employed in the primary crushing. This kind of crusher has larger reduction ratio, simple structure and can produce uniform particle sizes while the operating and maintenance cost of the equipment is relatively high, which is suitable for crushing materials with complicated components and properties such as construction waste.

The primary crushing may be divided into two steps if necessary. Jaw crusher will be used in the first step to break big pieces into smaller ones and roll crusher will be used in the second step to break the materials of higher rigidity to middle or fine crushing.

The gravity separation can adopt multilevel jig separation or other suitable separating techniques to divide the waste into heavy material which is heavier than mineral material and mainly consists of metal, light material which is lighter than mineral material and mainly consists of organic material as well as the mineral material. The heavy material and light material can be recycled according to their own characters.

If necessary, Second magnetic separation will be carried out after the gravity separation to separate the iron materials.

Roll crusher or ball miller will be employed in the secondary crushing of the mineral material.

A third magnetic separation will be carried out after the secondary crushing to further separate the remained iron among the mineral materials.

The low-water will adopt 425# low-water cement.

The fibrous material can adopt natural vegetable fiber or synthetic fiber such as fiberglass.

Other materials may include fly ash. Under above ratio, an addition of 0-30 portions may be used. For fly ash owns certain hydraulic property and binding power, which not only play the role of filling, but also has some effects on the intensity comparing the mineral from the construction waste.

The other materials may also adopt various mineral grains, such as metallurgical tailing.

The other materials may also adopt early strength agent and/or water reducing agent in other materials. The early strength agent is for early demould and improving productivity effect while the water reducing agent is for reducing water consumption and improving compactness and intensity. The components and dosages of the two agents will be selected according the present techniques, the testing data of different agent as well as the application specification.

There are several instances of material ratios as following, while the early strength agent and water reducing agent can be selected according to actual needs and present techniques involved.

Instance 1: fibrous material 5 kg, mineral material 60 kg, and low-water cement 20 kg

Instance 2: fibrous material 10 kg, mineral material 40 kg, low-water cement 30 kg, and fly ash 30 kg

Instance 3: fibrous material 7 kg, mineral material 50 kg, and low-water cement 25 kg

Instance 4: fibrous material 5 kg, mineral material 60 kg, low-water cement 28 kg, and fly ash 10 kg

Instance 5: fibrous material 5 kg, mineral material 40 kg, low-water cement 20 kg, and fly ash 30 kg

Instance 6: fibrous material 10 kg, mineral material 60 kg, low-water cement 20 kg, and fly ash 8 kg

Instance 7: fibrous material 10 kg, mineral material 40 kg, low-water cement 30 kg, and mine tailing 10 kg

What is claimed is:

1. A method for turning construction wastes into building materials, said method separating construction wastes into heavy materials, light materials and mineral materials by sorting, magnetic separating, primarily crushing and separating by gravity, said mineral materials to be used as raw materials of building material, said building materials comprising fibrous material of 5-10 portions, said mineral material of 40-60 portions, low-water cement of 20-30 portions and other materials of 0-30 portions.

2. The method of claim 1 wherein manufacturing process of said building material is firstly mixing the fibrous material, the mineral material and other materials uniformly, then mixing the low-water cement in and blending the mixture into slurry by adding water, finally pouring the slurry into moulds and vibrating or pressing to form it into shape, and building slabs will come into being after natural curing.

3. The method of claim 1 wherein a sorting will be performed by manual work or machines to select staple or massive steel bars, boards or other materials from the mineral material in building wastes. The other separated stuffs include metal material, wooden material and organic materials like plastic.

4. The method of claim 1 wherein a magnetic separation will follow the sorting. Suspended suction magnetic separator will be employed in the magnetic separation to separate the remained iron pieces from the waste.

5. The method of claim 1 wherein a jaw crusher will be employed in the primary crushing or the primary crushing may be divided into two steps. Jaw crusher will be used in the first step to break big pieces into smaller ones and roll crusher will be used in the second step.

6. The method of claim 1 wherein a gravity separation will divide the waste into heavy material which is heavier than mineral material and mainly consists of metal, light material which is lighter than mineral material and mainly consists of organic material as well as the mineral material. Second magnetic separation will be carried out after the gravity separation.

7. The method of claim 1 wherein a roll crusher or a ball miller will be employed in the secondary crushing of the mineral material and third magnetic separation will be carried out after the secondary crushing.

8. The method of claim 1 wherein the low-water cement will adopt 425# low-water cement and the fibrous material will adopt fiberglass.

9. The method of claim 8 wherein other materials include fly ash with a addition of 0-30 portions.

10. The method of claim 9 wherein there are also early strength agent and/or water reducing agent in other materials.

11. The method of claim 2 wherein the sorting will be performed by manual work or machines to select staple or massive steel bars, boards or other materials from the mineral material in building wastes while the other separated stuffs include metal material, wooden material and organic materials such as plastic.

12. The method of claim 2 wherein a magnetic separation will follow the sorting. Suspended suction magnetic separator will be employed in the magnetic separation to separate the remained iron pieces from the waste.

13. The method of claim 2 wherein a jaw crusher will be employed in the primary crushing or the primary crushing may be divided into two steps. Jaw crusher will be used in the first step to break big pieces into smaller ones and roll crusher will be used in the second step.

14. The method of claim 2 wherein a gravity separation will divide the waste into heavy material which is heavier than mineral material and mainly consists of metal, light material which is lighter than mineral material and mainly consists of organic material as well as the mineral material. Second magnetic separation will be carried out after the gravity separation.
The method of claim 2 wherein a roll crusher or a ball miller will be employed in the secondary crushing of the mineral material and a third magnetic separation will be carried out after the secondary crushing.

16. The method of claim 2 wherein the low-water cement will adopt 425 #low-water cement and the fibrous material will adopt fiberglass.

17. The method of claim 16 wherein other materials include fly ash with a addition of 0-30 portions.

18. The method of claim 17 wherein there are also early strength agent and/or water reducing agent in other materials.
